(19) United States
(12) Patent Application Publication
(10) Pub. No.: US 2025/0260856 A1
(43) Pub. Date: Aug. 14, 2025

(54) SYSTEM AND METHOD FOR SHARING MUSICAL COMPOSITIONS

(71) Applicants: Lois Noel Morgan, Martinsburg, WV (US); Anthony Carter, Martinsburg, WV (US)

(72) Inventors: Lois Noel Morgan, Martinsburg, WV (US); Anthony Carter, Martinsburg, WV (US)

(21) Appl. No.: 19/050,051

(22) Filed: Feb. 10, 2025

Related U.S. Application Data
(60) Provisional application No. 63/551,983, filed on Feb. 9, 2024.

(51) Int. Cl. H04N 21/262; G06F 9/451; G06Q 30/0207

(52) U.S. Cl. CPC H04N 21/26258; G06F 9/451; G06Q 30/0207

(57) ABSTRACT

A system for listing and radio broadcasting of musical compositions by new and independent artists. The method includes receiving musical compositions from the artists through an interface implemented on a user device. The system further receives playback schedules for the musical compositions from the artists. The system then broadcasts the musical compositions based on the respective playback schedule. The system allows listeners to vote for their favorite artists. Artists getting maximum votes in a predefined duration can be given cash prizes. Also, the system allows the artists to contract with external radio stations to play their musical compositions on these radio stations.

### CROSS REFERENCE TO RELATED APPLICATIONS

This application claims priority from a U.S. Provisional Patent Application No. 63/551,983, filed on Feb. 9, 2024, which is incorporated herein by reference in its entirety.

### FIELD OF INVENTION

The present invention relates to a system and method for sharing musical compositions, and more specifically, the present invention relates to a system and method that allows new and independent artists to broadcast their musical compositions to public in large.

### BACKGROUND

Various kinds of musical compositions including songs have become a main source of entertainment for many people. The Internet has made accessibility to libraries of old and new musical compositions easy and quick. Various media platforms, such as YouTube® and Spotify®, are available on the internet, which hosts a huge library of musical compositions. Such platforms allow the users to search for musical compositions using names, artists, genre, year of release, and the like parameters. Such platforms also provide for the creation of playlists, like musical compositions, and the like.

The known platforms for sharing musical compositions are good for popular artists as the new releases quickly reach the listeners at large. However, new artists often have difficulty finding a place to share their music with the larger listener, and many times they are overlooked because they cannot get a spot on the radio for their music to be heard. Radio stations and media platforms are sponsored or facilitated by big businesses, and these platforms typically remain biased toward certain artists because of the profits. For new artists, it becomes extremely difficult to get attention to their musical compositions no matter how good the musical compositions are.

Thus, a need is appreciated for a system and method that can provide an unbiased and even platform for new artists to present their creations and reach listeners at large.

The term “musical composition” hereinafter may refers to all type of musical compositions including songs, and with or without video or any kind of graphics and visualizations.

The term “artist” herein after refers to a person or a group of person that create or helped in creating the musical composition.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for listing and broadcasting musical compositions by artists.

Another object of the present invention is that the artists can manage their listings and playback schedules.

Still, another object of the present invention is that the system and method do not cause any bias towards artists.

A further object of the present invention is that the system and method allow listeners to rate the musical compositions and the artists.

Still a further object of the present invention is that the system and method allow the artists to populate their musical compositions to other popular platforms.

Yet a further object of the present invention is that the listener can search for musical compositions and artists through a variety of keywords.

An additional object of the present invention is that notifications can be displayed to users.

Still an additional object of the present invention is that artists can be rewarded for good work.

Still an additional object of the present invention is that the rewards can be cash prizes.

Yet an additional object of the present invention is that the system includes a subscription-based model.

A system and method for listing and radio broadcasting of musical compositions by independent and less-known artists, the system includes a signal broadcasting unit comprising a radio transmitter for transmitting radio signals to one or more satellites; a processor; and a memory operably coupled to the processor, the memory comprises a plurality of modules which upon execution by the processor implements a method. The method comprises: receiving one or more musical compositions from a user through an interface implemented on a user device by the system; presenting a configuration screen of the interface on the user device, wherein the configuration screen is configured to allow configuring a playback schedule for each of the one or more musical compositions; receiving, by the system, the playback schedule from the user device; broadcasting the one or more musical compositions based on the respective playback schedule by the system.

In one aspect, the method further comprises presenting a profile screen of the interface on the user device, wherein the profile screen is configured to allow listeners to vote for artists and digitally follow the artists.

In one aspect, the method further comprises determining an artist receiving maximum votes in a predetermined duration; presenting a profile of the artist through a weekly winner screen of the interface on the user device; and notifying cash prizes for the artist.

In one aspect, the method further comprises presenting a search screen of the interface on the user device, wherein the search screen is configured to receive keywords for searching musical compositions and artists.

In one aspect, the method further comprises facilitating an artist registered with the system to schedule a playback of a musical composition in an external radio station; and generating a smart contract between the registered artist and the external radio station, wherein the smart contract comprises the schedule of the playback.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a block diagram showing the environment of the system, according to an exemplary embodiment of the present invention. The system can connect to an artist device and an listener device through suitable networks. The artists and the listener are users who use the disclosed system.

FIG. 2 is a block diagram showing the architecture of the system, according to an exemplary embodiment of the present invention. The system includes a processor and a memory. The memory may include various modules, such as user, subscription, playback, and interface modules. These modules are part of the disclosed system and method and upon execution by the processor may perform one or more steps of the disclosed methodology.

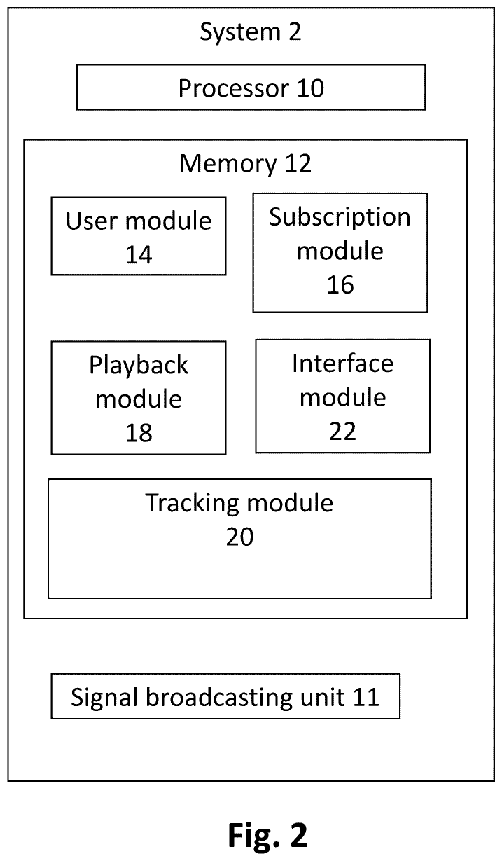

FIG. 3 shows a registration screen, according to an exemplary embodiment of the present invention. The registration screen through a form can receive information from a user for creating an account of the user.

FIG. 4 shows a menu screen of the interface, according to an exemplary embodiment of the present invention. The menu screen may have links to other screens, such as the notification screen and setting screen. It is to be noted that the menu screen in FIG. 4 shows two links, however, other options can be included. Also, a navigation bar is visible at the bottom of the menu screen.

FIG. 5 shows a settings screen of the interface, according to an exemplary embodiment of the present invention.

FIG. 6 shows a notification screen of the interface, according to an exemplary embodiment of the present invention. The notification screen may show all the artists that have won till now in the current year.

FIG. 7 shows a subscription fee screen of the interface, according to an exemplary embodiment of the present invention.

FIG. 8 shows a home screen of the interface, according to an exemplary embodiment of the present invention.

FIG. 9 shows a media submission screen of the interface, according to an exemplary embodiment of the present invention.

FIG. 10 shows another submission screen of the interface, according to an exemplary embodiment of the present invention.

FIG. 11 shows a public profile screen of the interface, according to an exemplary embodiment of the present invention.

FIG. 12 shows an artist-by-week screen of the interface, according to an exemplary embodiment of the present invention.

FIG. 13 shows a weekly winner screen of the interface, according to an exemplary embodiment of the present invention.

FIG. 14 shows a search screen of the interface, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The invention described herein pertains to a system and method for listing and managing musical compositions, and digital radio broadcasting of the musical compositions. The term “musical composition” herein refers to songs, audio notes, tunes, and the like. The term “broadcasting” herein refers to the electronic transmission of radio signals, including digital satellite broadcasting. Also, it is to be understood that the terms music, song, media, and soundtrack may be interchangeably used hereinafter, and refer to the musical composition. The disclosed system allows the playing of independent artist's music. The system may avoid any bias based on profiteering and provides good opportunities for new and independent artists. Artists who are not associated with big media agencies are given a platform to broadcast their musical compositions through the disclosed system. New independent artists can get opportunities to have their musical compositions heard and recognized. Also, the system provides opportunities for the public to listen to new musical compositions from new and lesser-known artists. The disclosed system may provide a platform for new artists to showcase their musical compositions and further explore new arenas to reach larger listeners. For example, media agencies can contract with artists on this platform, wherein the system can facilitate interaction between external agencies and the user of the disclosed system.

The artists through an interface implemented by the system can submit their musical compositions to other top radio stations in the country and worldwide. These radio stations can connect with the disclosed system to participate in the network that may allow playing musical composition on their radio stations. The system may also provide for creating smart contracts of the artists with external radio stations. Such contracts may include musical composition and their playback schedule. The system may limit the number of musical compositions of any artist that can be played on a particular external radio station. This may eliminate any chances of the station being bombarded with too many musical compositions from one artist.

The system and method may also provide for rewarding the artists using the disclosed system. The rewards can be in the form of cash prizes. The system allows listeners to rate the musical compositions and artists, based on which respective artists can be rewarded. For example, a person who listens to a song can give a rating for the song on the disclosed platform through an interface implemented by the system. Artists for the songs can be rewarded based on votes that they received, and thus any bias can be avoided. The users may also be provided with options to make charity i.e., donate to listed charitable institutions through the interface implemented by the disclosed system.

The disclosed system may also provide an interface that allows a user to submit musical compositions. The interface allows the user to manage their listing of their musical compositions. The management may include when and how long the musical compositions will be played. The system may provide a subscription-based model for musical composition submission; thus, the user may have to pay for playing the musical composition. Artists whose musical compositions are liked by many can be rewarded in terms of cash.

The disclosed system is advantageous in that the system provides independent music artists with the opportunity to choose which of their musical compositions they would like listeners to hear and when as well as a platform where listeners can listen to the new music they want to hear. The disclosed system may act as an outlet for the thousands of artists who eagerly want their musical compositions to be heard and distributed to the masses. The system may provide integral links to listen to and purchase musical compositions from streaming sites such as Apple® Music. The disclosed system may help support the voices of aspiring musicians and the voices of people who want to see positive changes in the world. The disclosed system and method contribute to the sharing of music that otherwise may have never been heard. Also, the new and existing enterprises can connect with the disclosed system for talent search.

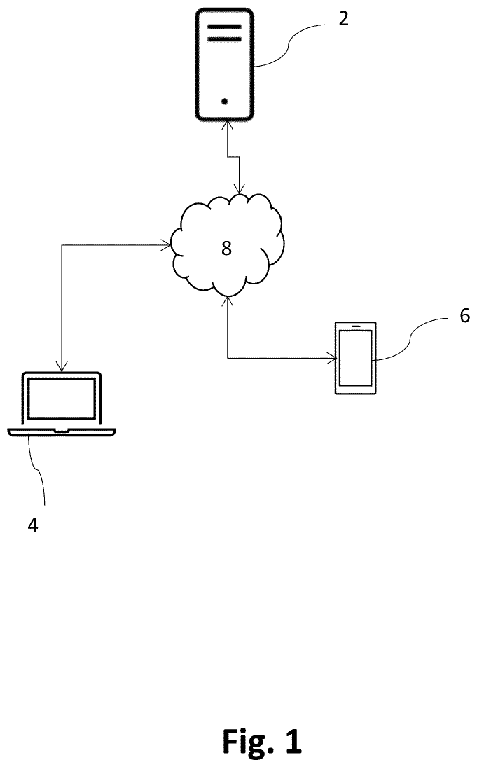

Referring to FIG. 1, which is a block diagram showing an environment of the disclosed system 2. The system 2 can connect to an artist device 4 and a listener device 6 through network 8. The artist and the listener are also referred to herein as a user. The artist may be a person who uses their user device to upload musical compositions to the system or a link to the musical compositions stored somewhere else. The listener may be any person who listens or wishes to listen to the musical composition available or broadcasted by the system. The term “user” as used herein, and throughout this disclosure, refers to an individual engaging a user device to interact with the system. Similarly, the term user device encompasses artist devices and listener devices. The user device can be any computing device that includes a processor for processing instructions stored in memory. The user device can also include an input module for receiving input from the user. Such input can be in the form of a touch display, mouse, stylus, keyboard, touchpad, and the like. The user device may also include a display for presenting information to the user, for example, an LCD screen. The user device may also include a network circuitry for connecting to the network 8. Examples of user devices include a smartphone, a desktop computer, a laptop, a workstation, and the like. The user device of the listeners may be in the form of a radio and may also include headphones.

The network can be a communication network known in the art which can be a wired network, a wireless network, or may include a combination of wired and wireless networks. Examples of communication networks may be a local area network (LAN), a wide area network (WAN), a wireless WAN, a wireless LAN (WLAN), a metropolitan area network (MAN), a wireless MAN network, a cellular data network, a cellular voice network, the Internet, etc. The network herein may also include radio networks and signal broadcast networks. For example, the system through radio networks can broadcast radio signals. While, for the purpose of illustration herein, FIG. 1 shows a single network connecting multiple user devices, it should be obvious to those reading this disclosure that different user devices can connect with the system through different networks, and the same user device can connect with the system through more than two networks. For example, a user device can connect to the system through a LAN and the Internet. Also, audio signals can be transmitted to the user device through the signal broadcast networks. It is to be understood that the disclosed system may connect to radio stations and radio signal broadcasting network satellites for transmission of audio signals to the user devices.

System 2 includes a processor 10 and a memory 12 operably coupled to the processor. The processor can be any logic circuitry that responds to, and processes instructions fetched from the memory. The memory may include one or more memory chips capable of storing data and allowing any storage location to be directly accessed by the processor. The memory can include modules according to the present invention for execution by the processor to perform one or more steps of the disclosed methodology.

The memory may include a user module 14 which upon execution by the processor can allow a user to register with the disclosed system; a subscription module 16 which upon execution by the processor may allow a user to upload musical composition and schedule playback of the musical composition; a playback module 18 which upon execution by the processor provides for playback of musical composition and listening of the musical composition; a tracking module 20, which upon execution by the processor allow for voting by users and rating of the artists; and interface module 22, which upon execution by the processor can provide an interface on a user device for interacting with the disclosed system.

The term module as used herein and throughout this disclosure refers to software, a program code, a set of rules or instructions, and the like in one or more computer-readable languages including graphics, which upon execution by the processor performs one or more steps of the disclosed methodology. Also, operations may be described as a sequential process, some of the operations may be performed in parallel, concurrently, and/or in a distributed environment, and with program code stored locally or remotely for access by single or multi-processor machines. In addition, in some implementations, the order of operations may be rearranged without departing from the spirit of the disclosed subject matter.

The system may also include a signal broadcasting unit 11 that may allow for broadcasting of radio signals to the user devices. The radio signals may be broadcast on digital radio networks. The radio signals may be transmitted through satellites, wherein the signal broadcasting unit 11 can send the signal to a geostationary satellite which can reflect the signals to the user device. For example, the signal can be transmitted to an audio unit of a car through a satellite. The signal broadcasting unit 11 may include radio transmitters for transmitting the radio signals to suitable satellites.

The system can be implemented in the form of servers, which include cloud servers. The servers can be placed in one location or geographically dispersed. Also, one or more steps of the disclosed methodology can be performed on one or more user devices without departing from the spirit of the disclosed subject matter. The disclosed system may also include a base station and a radio network controller for broadcasting audio signals to multiple devices.

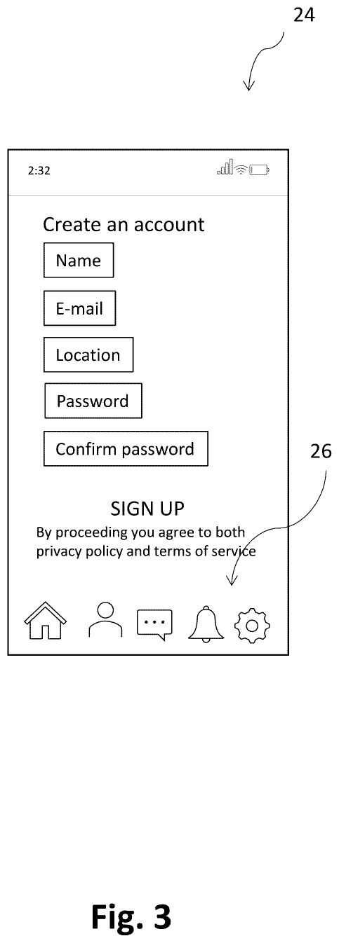

The interface provided by the interface module 22 allows a user to interact with the disclosed system through a user device. The interface may include a series of screens, as shown in FIGS. 3-14, which in continuation can provide information as well as receive information from the user and execute one or more steps of the disclosed methodology. The interface can be dynamic and allows switching between sections, screens, pages, and the like quickly and easily. The interface can be provided as an application software that can be installed on the user device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the World Wide Web. The application software can also be provided for the desktop environment, such as Windows™, Linux, and macOS. The user interface may permit interaction with a user through the user device, wherein information can be presented within the user interface by system 2 and information can be received by system 2 from the user.

The user module 14 may allow an individual willing to use the disclosed system to register. The user module can receive basic information about the individual, such as name, contact details, email address, and the like. Referring to FIG. 3 which shows a registration screen 24 of the interface implemented by the system. The registration screen includes a form for receiving data in an organized manner from the user. For account creation, basic information like name, E-mail address, residential address, passwords, and the like may be obtained from the user.

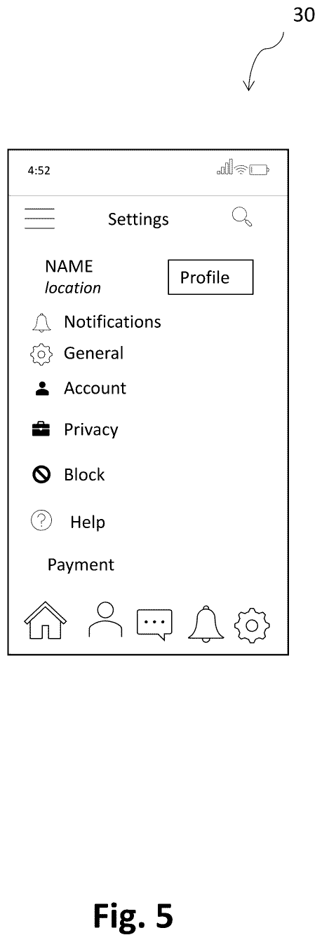

The user module can generate a profile for the user and store the same in a suitable database. The databases, including their structure and functioning, are known in the art. Also, the use of blockchain databases is well known. In the database, the information may typically be stored in the form of tables having headers and columns. This may allow the data to be stored in a quarriable format. The present invention may use any suitable database without departing from the scope of the present invention. Also, the profile created by the user module can be later modified by the user. For example, FIG. 5 shows a settings screen 30 that includes the option “profile” as a soft button. Clicking this soft button opens up another screen that may present the profile as a form. The user has the option to edit entries or add more information, and the user module can update the respective profile in the database.

The user module can generate login details to access the disclosed system securely. The login details may include at least a username and a password. The password can be an alphanumeric code, or biometric like a fingerprint, token, and the like. The user may have multiple login options, such as using an alphanumeric code or a fingerprint. Also, the use of multiple-factor authentication is within the scope of the present invention. The user can be provided with a login screen on the user device for accessing the disclosed system.

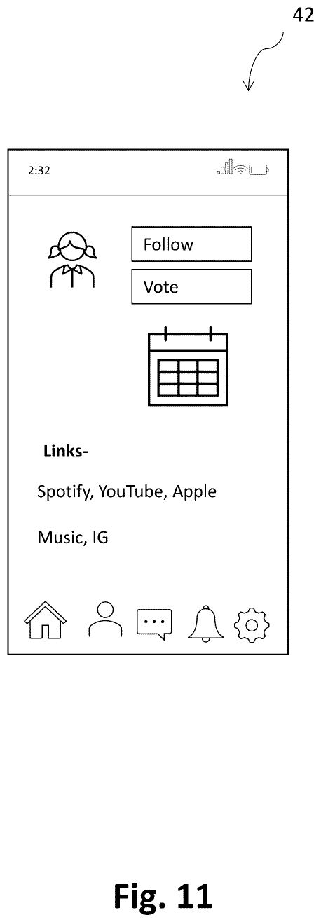

Some information from the profile can be used to generate a public profile. The public profiles can be visible to other users. In certain implementations, the public profile may include a photograph, name, interest in music, ratings, and location information. The public profile may also include options for voting for an artist user and following the artist. The voting may be to rate the artist. For example, the listeners of songs published by the artists can vote for the artist based on the song. To “follow” may allow the user to keep track of the new releases and news from the artists whom they are following. The user following may know about the public activities of the artist being followed. For example, the listener following an artist may be notified when a new song is released by the artist. The public profile may also include links to media already published by the artists. For example, the profile shown in FIG. 11 has YouTube® and Spotify® links which may open channels or playlists containing songs of the user. All such may be provided in the form of buttons on the public profile, wherein a user can click a respective soft button. The information on the public profile may be obtained from different sources. Ratings of the artists may also be displayed on the public profile of the artists, wherein such information can be fetched from their accounts.

For each public profile, suitable keywords can be generated based on the information in the profile. These keywords can be used to search for a public profile. For example, a user wishing to listen to a song may search using keywords like the name of the artist or genre of the song.

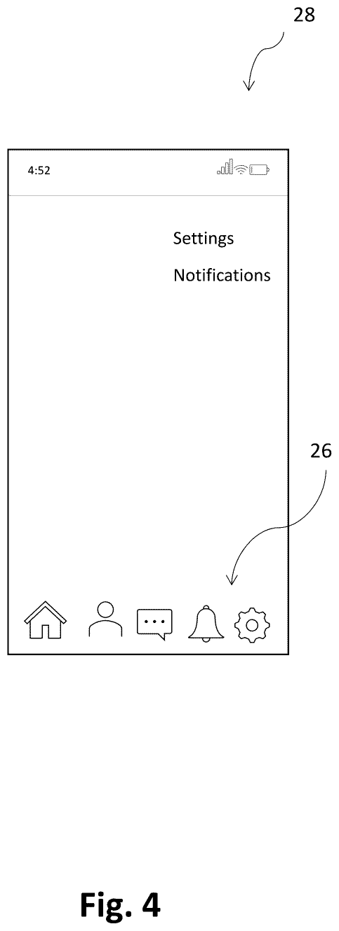

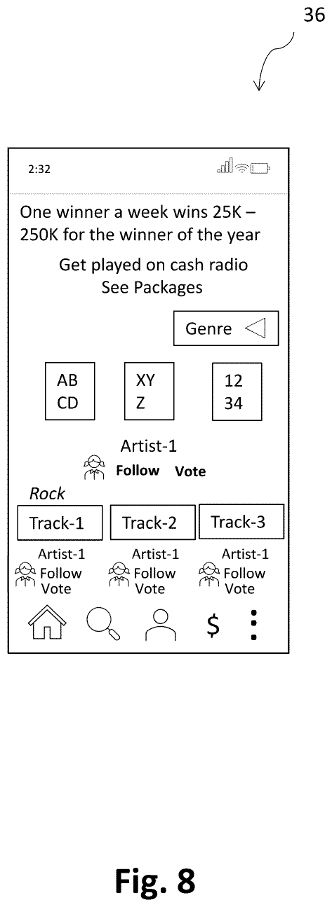

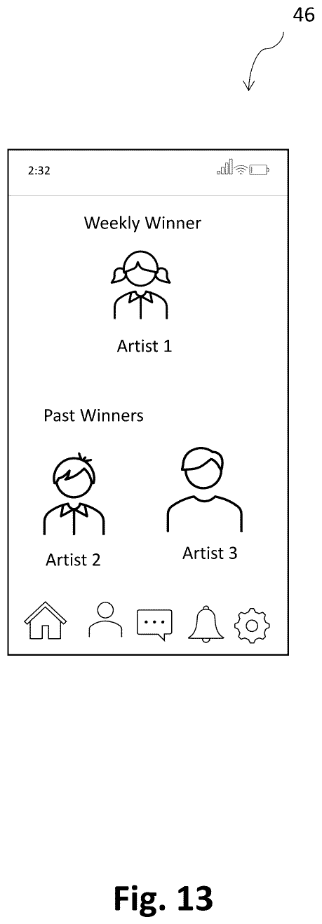

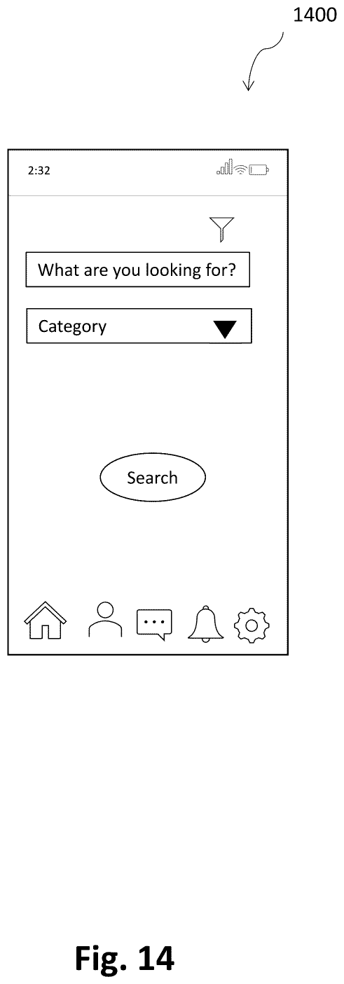

Referring to FIG. 4 shows a menu screen 28 of the interface that may be displayed to the user when the user accesses the disclosed system through the login interface. The menu screen may have links to other screens, such as the notification screen and setting screen. It is to be noted that the menu screen in FIG. 4 shows two links, however, other options can be included. Also, a navigation bar 26 is shown at the bottom of the menu screen. The navigation bar may be visible on most of the screens of the interface and may provide a quick way to navigate to different screens of the interface. The navigation bar may include links to different screens in the form of icons. The first icon is of a home shape and may link to the home screen of the interface. The second icon may open the public profile of the user. The third icon may include a chat or message option, that may be used to send messages to other users. A bell- shaped icon may be linked to the notification screen. The last icon of a wheel shape icon may be linked to the settings screen. It is understood that the various options may be included in the navigation bar. For example, FIG. 8 shows the navigation bar having different icons that may open different pages. The lens shape icon may open a search screen of FIG. 14. The dollar shape icon may open a weekly winner screen as shown in FIG. 13. The three dots in the last of the navigation bar may open the menu screen of FIG. 3.

Referring to FIG. 5 which shows the settings screen 30 of the interface. The settings screen may be opened through menu screen 24 or through navigation bar 26. The settings screen may include different configurations and permissions that can be changed. FIG. 5 shows the option for configuring the profile, notifications, account, and privacy. Also, a list of blocked people can accessed from here and any changes can be made. The settings screen may also show the name and location of the user. There may also be an option to reach help, through which different options such as instruction manuals, public forums, etc. can be accessed for seeking help. The payment gateway can also be configured through the settings screen.

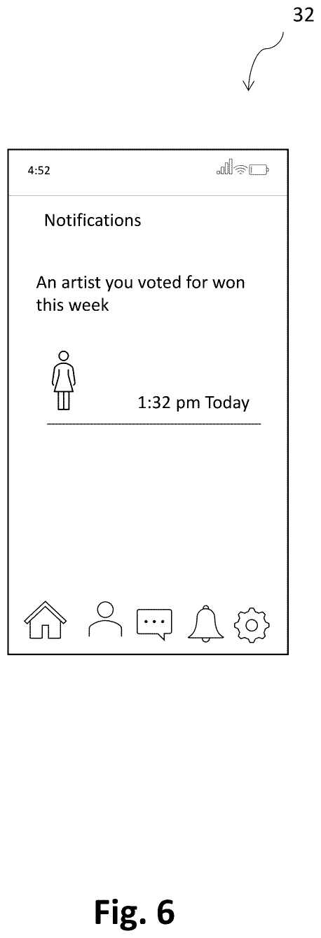

FIG. 6 shows a notification screen 32 which can show different notifications to the user. FIG. 6 shows a notification that the artist for which the user voted has won. Similarly, any kind of notification can be presented to the user through the notification screen. The notification screen may be accessible through the menu screen 28 and the navigation bar 26.

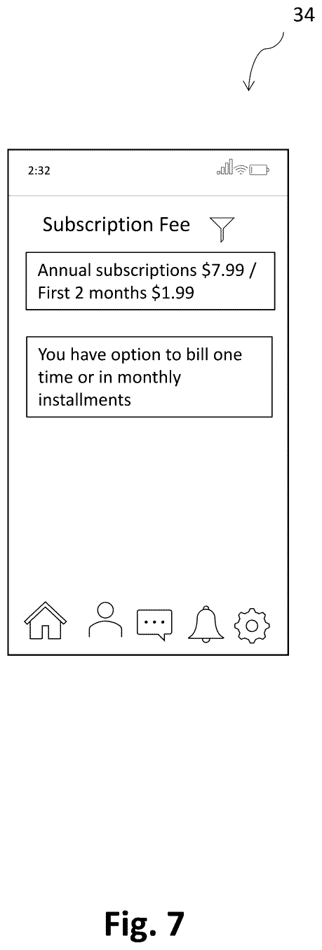

The system 2 through the subscription screen 34, shown in FIG. 7, may show the subscription fee for the artists. The artists broadcasting their musical compositions to the listeners may have to pay for the broadcasting depending on the playback schedule and time of play. The system may provide different subscription options for the artist to choose from.

FIG. 8 shows a home screen 36 that may be displayed to the user. The screen 36 may be for the user who wishes to upload media for playback by the disclosed system. The home screen may show the rewards available for artists and some public profiles of highly voted artists. Through the home screen, the user can access the watch lists and artists followed by the user. The home screen may also show new musical compositions that are released by the user. The home screen may also show the new artists whom the user can follow and vote for.

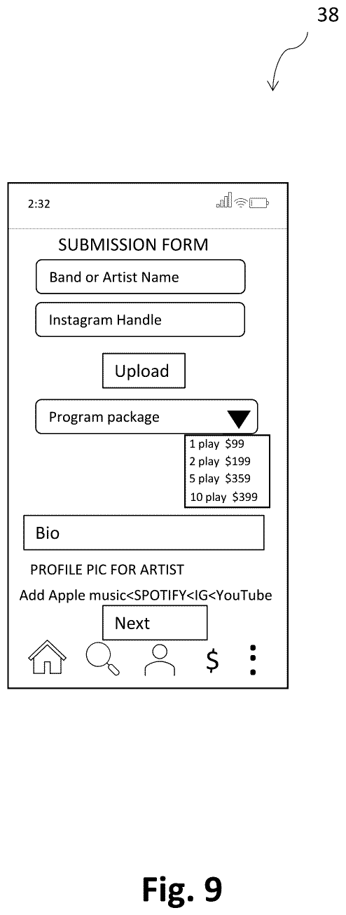

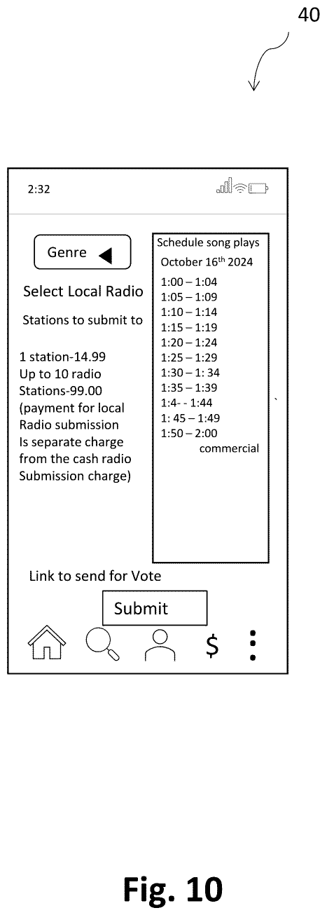

FIG. 9 shows subscription screen 38 of the interface which can be for artists to submit their songs. The submission screen may receive information about the song being submitted through a form shown in FIG. 9. FIG. 10 shows another part of the submission screen 40 that may be used to schedule the playback of the submitted music composition. On the screen 40, multiple slots are given which the user can select for playing their musical composition. The slots are of four-minute durations with a ten-minute commercial. It is to be noted that this information is for illustration only and the duration of slots and commercials can vary without departing from the scope of the present invention. FIG. 11 shows the public profile screen 42 which may be present the public profile of a user. Through this profile, a user can follow or vote for the artist. Also, links to external radio stations are included which play the musical compositions of the artists.

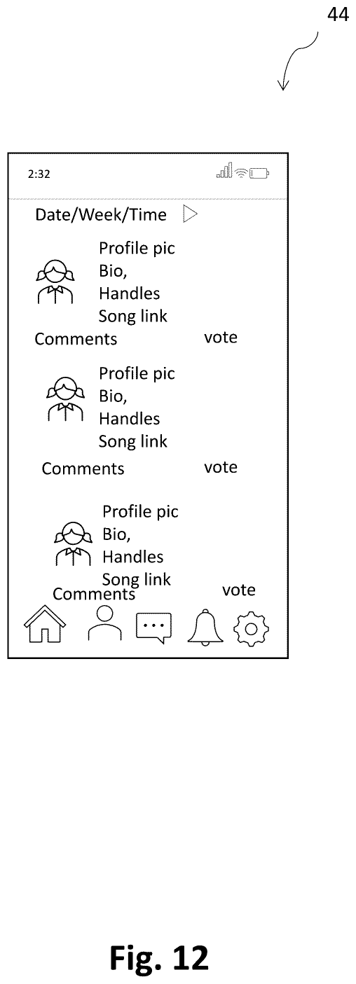

The system may allow a user to vote for the artists listed on the platform through the interface implemented by the system. Such voting by the user can be tracked by tracking module 20. FIG. 12 shows an artist-by-week screen 44 of the interface in which different artists are shown and the user may have an option to vote for their artists. The screen 44 allows users to see the winning artists in any period, wherein date-based filters can be used to list the artists.

FIG. 13 shows a weekly winner screen 46 of the interface that may show weekly winners and past weekly winners. The tracking module 20 based on voting can determine a weekly winner artist, which can be rewarded, and the name of whom can be displayed to the user through the weekly winner screen 46. The user can scroll through the list of past weekly winners. FIG. 14 shows a search screen that may be used by a user to search for musical compositions. Various filters and keywords may be used to get the desired musical compositions. Also, the user can search musical compositions based on category.

The foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for listing and radio broadcasting of musical compositions by independent and less-known artists, the system comprising:
a signal broadcasting unit comprising a radio transmitter for transmitting radio signals to one or more satellites;
a processor; and
a memory operably coupled to the processor, the memory comprises a plurality of modules which upon execution by the processor implements a method, the method comprising:
receiving one or more musical compositions from a user through an interface implemented on a user device by the system;
presenting a configuration screen of the interface on the user device, wherein the configuration screen is configured to allow configuring a playback schedule for each of the one or more musical compositions;
receiving, by the system, the playback schedule from the user device;
broadcasting the one or more musical compositions based on the respective playback schedule by the system.

2. The system of claim 1, wherein the method further comprises:
presenting a profile screen of the interface on the user device, wherein the profile screen is configured to allow listeners to vote for artists and digitally follow the artists.

3. The system of claim 2, wherein the method further comprises:
determining an artist receiving maximum votes in a predetermined duration;
presenting a profile of the artist through a weekly winner screen of the interface on the user device; and
notifying cash prizes for the artist.

4. The system of claim 3, wherein the method further comprises:
presenting a search screen of the interface on the user device, wherein the search screen is configured to receive keywords for searching musical compositions and artists.

5. The system of claim 4, wherein the method further comprises:
facilitating an artist registered with the system to schedule a playback of a musical composition in an external radio station; and
generating a smart contract between the registered artist and the external radio station, wherein the smart contract comprises the schedule of the playback.

6. A method for listing and radio broadcasting of musical compositions, the method implemented within a system comprising:
a signal broadcasting unit comprising a radio transmitter for transmitting radio signals to one or more satellites;
a processor; and
a memory,
wherein the method further comprises:
receiving one or more musical compositions from a user through an interface implemented on a user device by the system;
presenting a configuration screen of the interface on the user device, wherein the configuration screen is configured to allow configuring a playback schedule for each of the one or more musical compositions;
receiving, by the system, the playback schedule from the user device;
broadcasting the one or more musical compositions based on the respective playback schedule by the signal broadcasting unit.

7. The method of claim 6, wherein the method further comprises:
presenting a profile screen of the interface on the user device, wherein the profile screen is configured to allow listeners to vote for artists and digitally follow the artists.

8. The method of claim 7, wherein the method further comprises:
determining an artist receiving maximum votes in a predetermined duration;
presenting a profile of the artist through a weekly winner screen of the interface on the user device; and
notifying cash prizes for the artist.

9. The method of claim 8, wherein the method further comprises:
presenting a search screen of the interface on the user device, wherein the search screen is configured to receive keywords for searching musical compositions and artists.

10. The method of claim 9, wherein the method further comprises:
facilitating an artist registered with the system to schedule a playback of a musical composition in an external radio station; and
generating a smart contract between the registered artist and the external radio station, wherein the smart contract comprises the schedule of the playback.
